(19) United States
(12) Patent Application Publication
(10) Pub. No.: US 2026/0203157 A1
(43) Pub. Date: Jul. 16, 2026

(54) Protection from Unwanted Behavior in Remote Appliances in a Decentralized Service Mesh

(71) Applicant: Dell Products L.P., Round Rock, TX (US)

(72) Inventors: Brian Rochford, Ovens (IE); Andrea Roggerone, Dublin (IE)

(21) Appl. No.: 19/023,245

(22) Filed: Jan. 15, 2025

(51) Int. Cl. G06F 11/07; G06F 11/30

(52) U.S. Cl. CPC G06F 11/0793; G06F 11/3006; G06F 2201/86

(57) ABSTRACT

A system can connect to cloud computing equipment of a cloud environment as part of a decentralized service mesh that comprises the cloud computing equipment of the cloud environment and the system via a connectivity mechanism that satisfies a security criterion, wherein a user-space connectivity application of the system is configured to facilitate communication with the decentralized service mesh, and wherein a kernel-space management application of the system is configured to monitor kernel events of the system. The system can monitor the kernel events at the system via the kernel-space management application to produce monitored kernel events. The system can, based on the monitored kernel events being determined to satisfy a risk criterion, take a remedial action with respect to connectivity with the cloud computing equipment of the cloud environment.

### BACKGROUND

A group of microservices can execute within a service mesh to collectively provide a computer service.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can connect to cloud computing equipment of a cloud environment as part of a decentralized service mesh that comprises the cloud computing equipment of the cloud environment and the system via a connectivity mechanism that satisfies a security criterion, wherein a user-space connectivity application of the system is configured to facilitate communication with the decentralized service mesh, and wherein a kernel-space management application of the system is configured to monitor kernel events of the system. The system can monitor the kernel events at the system via the kernel-space management application to produce monitored kernel events. The system can, based on the monitored kernel events being determined to satisfy a risk criterion, take a remedial action with respect to connectivity with the cloud computing equipment of the cloud environment.

An example method can comprise communicating, by a system comprising at least one processor, with network equipment of a cloud environment as part of a decentralized service mesh and via a connectivity mechanism that satisfies a security criterion, wherein a user-space connectivity application of the system is configured to facilitate communication with the decentralized service mesh. The method can further comprise monitoring, by a kernel-space management application of the system, kernel events of the system via to produce monitored kernel events. The method can further comprise, based on the monitored kernel events satisfying a risk criterion, facilitating, by the system, a remedial action being taken with respect to connectivity with the network equipment of the cloud environment.

An example non-transitory computer-readable medium can comprise instructions that, in response to execution, cause a system comprising a processor to perform operations. These operations can comprise, as part of communicating with a cloud environment as part of a decentralized service mesh and via a connectivity mechanism that satisfies a security criterion, monitoring, by a kernel-space management application of the system, kernel events of the system via to produce monitored kernel events, wherein a user-space connectivity application of the system is configured to perform the communicating. These operations can further comprise based on the monitored kernel events satisfying a risk criterion, initiating, by the system, a remedial action with respect to connectivity with the cloud environment.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate protection from unwanted behavior in remote appliances in a decentralized service mesh, in accordance with an embodiment of this disclosure;

FIG. 2 illustrates another example system architecture that can facilitate protection from unwanted behavior in remote appliances in a decentralized service mesh, in accordance with an embodiment of this disclosure;

FIG. 3 illustrates another example system architecture that can facilitate protection from unwanted behavior in remote appliances in a decentralized service mesh, in accordance with an embodiment of this disclosure;

FIG. 4 illustrates another example system architecture that can facilitate protection from unwanted behavior in remote appliances in a decentralized service mesh, in accordance with an embodiment of this disclosure;

FIG. 5 illustrates another example system architecture that can facilitate protection from unwanted behavior in remote appliances in a decentralized service mesh, in accordance with an embodiment of this disclosure;

FIG. 6 illustrates another example system architecture that can facilitate protection from unwanted behavior in remote appliances in a decentralized service mesh, in accordance with an embodiment of this disclosure;

FIG. 7 illustrates another example system architecture that can facilitate protection from unwanted behavior in remote appliances in a decentralized service mesh, in accordance with an embodiment of this disclosure;

FIG. 8 illustrates an example process flow that can facilitate protection from unwanted behavior in remote appliances in a decentralized service mesh, in accordance with an embodiment of this disclosure;

FIG. 9 illustrates another example process flow that can facilitate protection from unwanted behavior in remote appliances in a decentralized service mesh, in accordance with an embodiment of this disclosure;

FIG. 10 illustrates another example process flow that can facilitate protection from unwanted behavior in remote appliances in a decentralized service mesh, in accordance with an embodiment of this disclosure; and

FIG. 11 illustrates an example block diagram of a computer operable to execute an embodiment of this disclosure.

### DETAILED DESCRIPTION

### OVERVIEW

There can be scenarios that involve a decentralized service mesh running in a cloud computing environment. That is, control and management plane functions can be distributed across multiple nodes, rather than implemented a centralized control plane. Networking and communication features can be distributed among the participating nodes, enabling autonomy and resilience in the network infrastructure.

There are techniques for transparently extending a service mesh in a cloud environment to remote locations, using secure connectivity mechanisms. The present techniques can be implemented to protect this type of cloud environment from a compromised appliance in one of those remote locations.

The present techniques can facilitate activity monitoring. While the present techniques can be implemented to monitor activity against flexible profiles, examples of monitoring capabilities can help demonstrate their flexibility. Monitoring within the system can be based on events in the kernel. Examples of such events are as follows.

For traffic control (responding to ingress and egress traffic), the monitoring ability can relate to an appliance attempting to make unexpected connections. For a high-performance packet data path (processing outbound packets), the monitoring ability can relate to the appliance sending large amounts of data at a frequent rate to the cloud platform.

Other examples include:
A request_count can be captured by high-performance packet data path executions. If this exceeds a defined max_requests_per_sec, the secure connection can be terminated until the requests reduce to an acceptable level.
A bytes_count can be captured by high-performance packet data path executions. If this exceeded a defined max_bytes_per_sec, the secure connection can be terminated until the requests reduce to an acceptable level.
A pattern for acceptable hostnames can be defined within the activity monitoring program. If the appliance repeatedly tries to connect to hosts outside of this pattern via the secure connection, it can be terminated until the connectivity requests reduce to an acceptable level.
Other statistical data structures can also be used to allow for a time-series of allowable thresholds for each of the above monitoring capabilities.

The present techniques can be implemented to leverage secure connectivity mechanisms, in-kernel system and application introspection, and in-kernel advanced statistical data structures processing to identify unwanted operations on an authorized edge device. The present techniques can be implemented to block malicious requests and data on the edge by using a combination of the above mechanism and kernel-level operation monitoring. The present techniques can be implemented to transparently configure monitoring rules by pushing it through a secure connectivity mechanism and to inform the in-kernel bad actor detection.

The present techniques can provide the following advantages as compared to prior approaches. They can push computation to the edge by performing spam detection on the edge device. They can simplify cloud management by delegating profile enforcement to the edge device. They can configure activity profile rules transparently. They can block unwanted requests and data before it reaches cloud devices. A kernel-level implementation can make the present techniques portable between multiple appliances. The present techniques can block telemetry spamming and a large influx of data from an edge device towards the cloud.

The present techniques are different from prior approaches to authentication and authorization within service meshes. A network architecture according to the present techniques can differ from prior approaches in that the applications deployed within this service mesh can communicate securely with remote endpoints not directly connected. It can be that these remote endpoints can only be reached using secure communication mechanisms that create an encrypted and secure tunnel from the central hub's private network to each remote device.

The present techniques can facilitate moving through a decentralized service mesh through extending the mesh with underlying secure connectivity mechanisms according to the present techniques. Applications deployed in the private network of the central hub can transparently reach globally distributed remote devices that each located within their own private network, but are reachable via the available secure connectivity mechanism.

Dynamic routing, authentication and authorization via a tunneling mechanism can distinguish the present techniques from prior approaches.

There are prior approaches that can offer a local means of monitoring and detecting unauthorized access or suspicious activities. Resulting actions where an intrusion is detected can include alerting and integration with incident response systems to mitigate these threats. An example of this type of prior approach can be a Linux intrusion detection system (LIDS).

The present techniques can differ from these prior approaches, since these present techniques operate in a decentralized service mesh - such as a cloud platform whose service mesh has been extended to appliances in remote locations (that are not in the control of the cloud platform) via a secure connectivity mechanism. The activity monitoring in this system context can have a goal to protect the cloud platform from unwanted intrusions from remote appliances by terminating the secure connectivity path and removing them from the extended service mesh. Generally, the goal of these prior approaches has been to protect the appliances themselves without knowledge of the wider operating context.

Monitoring within a system according to the present techniques can be based on events in the kernel. Examples of such events can include the following. At the network level, there can be traffic control that responds to ingress and egress traffic. This can occur where an appliance attempts to make unexpected connections to the cloud platform or a known malicious host.

At the file system level, security modules can provide a mechanism to detect file-level access. This can occur where a local actor has accessed protected files within the appliance's operating system.

### Example Architectures

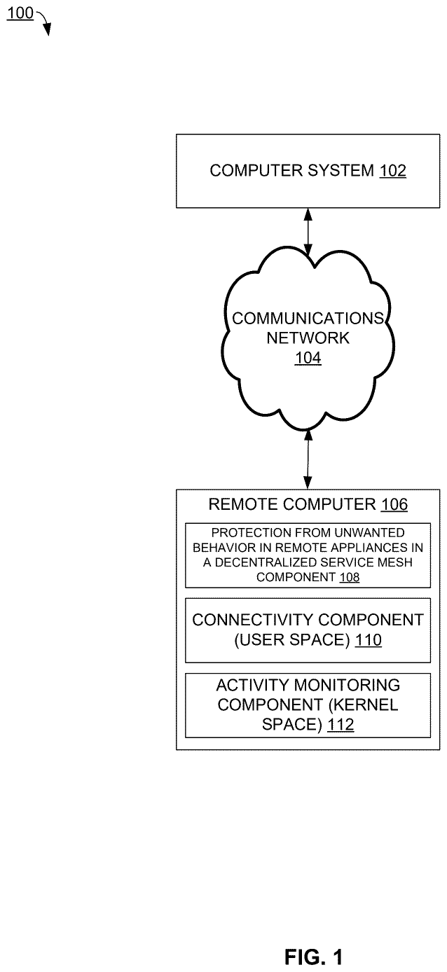

FIG. 1 illustrates an example system architecture 100 that can facilitate protection from unwanted behavior in remote appliances in a decentralized service mesh, in accordance with an embodiment of this disclosure.

System architecture 100 comprises computer system 102, communications network 104, and remote computer 106. Remote computer 106 comprises protection from unwanted behavior in remote appliances in a decentralized service mesh component 108, connectivity component (user space) 110, and activity monitoring component (kernel space) 112.

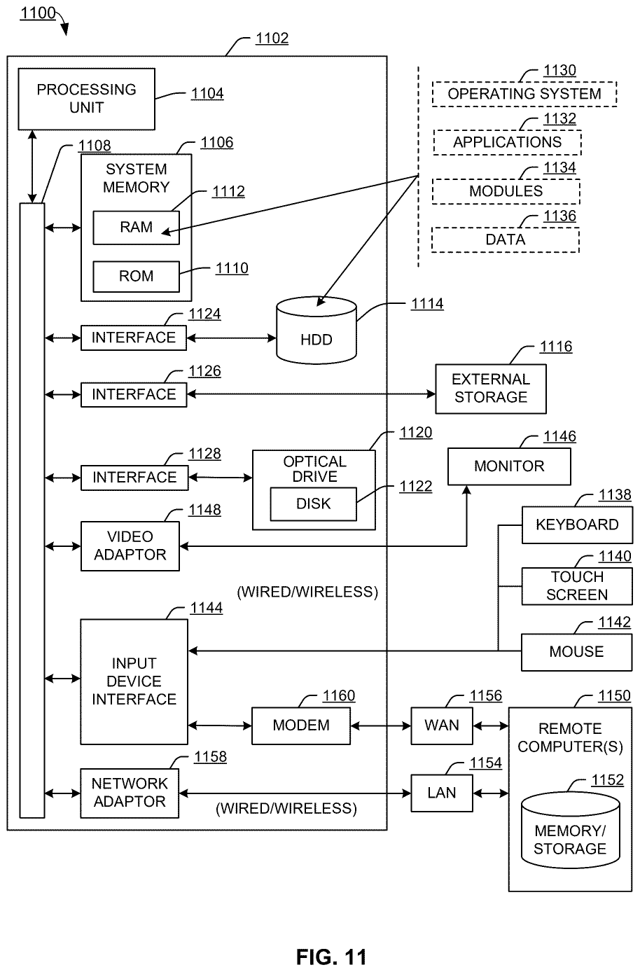

Each of computer system 102 and/or remote computer 106 can be implemented with part(s) of computing environment 1100 of FIG. 11. Communications network 104 can comprise a computer communications network, such as the Internet.

A decentralized service mesh that comprises computer system 102 can be extended to include remote computer 106, and this can be managed by protection from unwanted behavior in remote appliances in a decentralized service mesh component 108.

Connectivity component (user space) 110 can comprise an application that executes in a user space of remote computer 106, and activity monitoring component (kernel space) 112 can comprise an application that executes in a kernel space of remote computer 106. A memory space of remote computer 106 can generally be divided into a user space and a kernel space. A user space can generally comprise a memory area in which user applications operate. A kernel space can generally comprise a memory area in which the operating system kernel for computer system 102 operates.

Connectivity component (user space) 110 can communicate with computer system 102 via communications network 104, as part of the decentralized service mesh. Activity monitoring component (kernel space) 112 can monitor remote computer 106, and where remote computer 106 is detected to be performing undesirable activity (e.g., sending unwanted data to computer system 102), then protection from unwanted behavior in remote appliances in a decentralized service mesh component 108 can take a mitigating action (e.g., raising an alert, or terminating the connection between remote computer 106 and computer system 102).

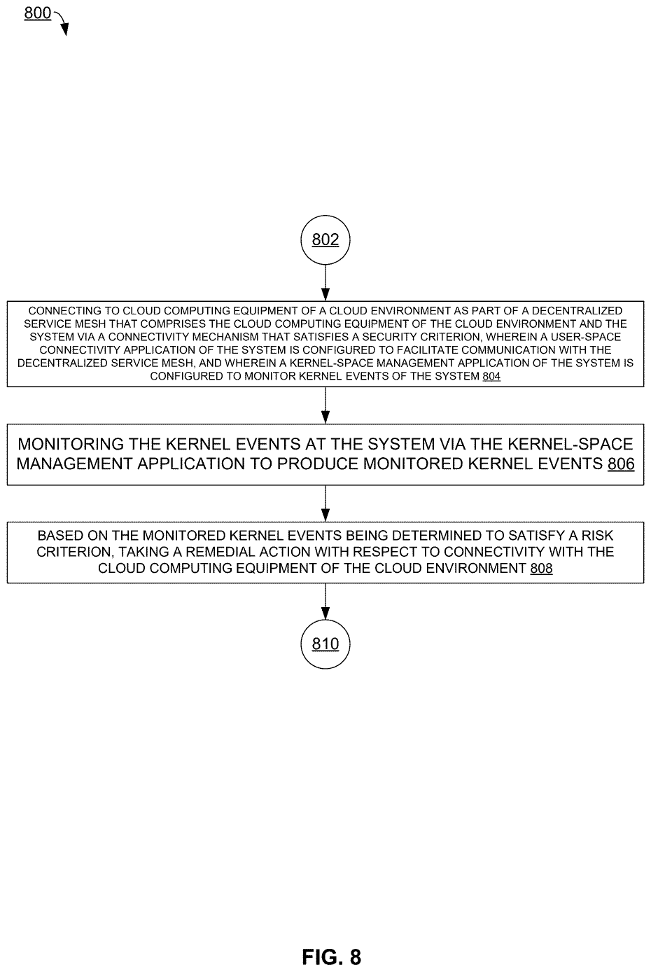

In some examples, protection from unwanted behavior in remote appliances in a decentralized service mesh component 108 can implement part(s) of the process flows of FIGS. 8-10 to implement protection from unwanted behavior in remote appliances in a decentralized service mesh.

It can be appreciated that system architecture 100 is one example system architecture for protection from unwanted behavior in remote appliances in a decentralized service mesh, and that there can be other system architectures that facilitate protection from unwanted behavior in remote appliances in a decentralized service mesh.

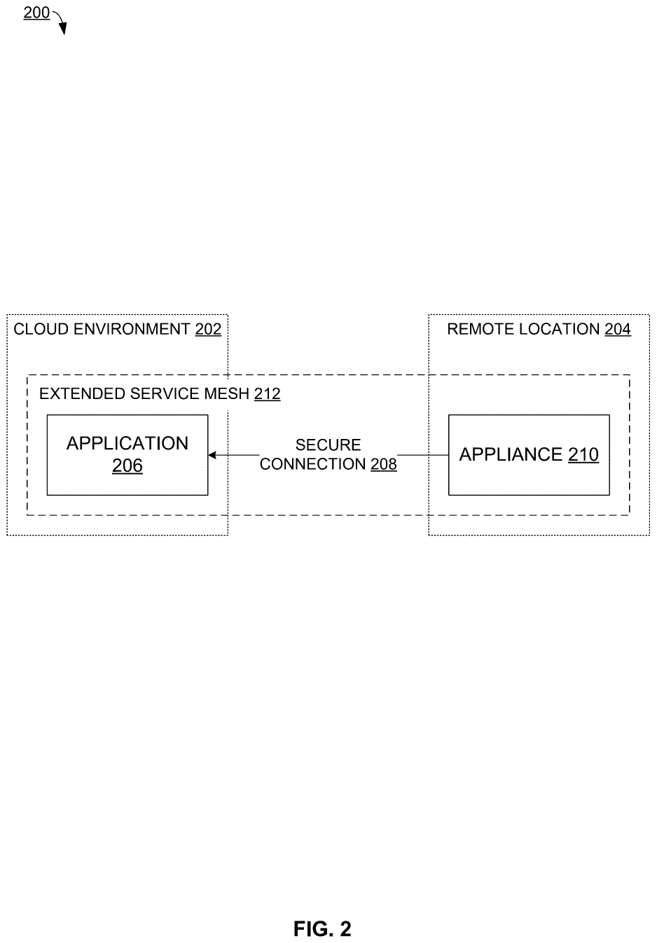

FIG. 2 illustrates another example system architecture 200 that can facilitate protection from unwanted behavior in remote appliances in a decentralized service mesh, in accordance with an embodiment of this disclosure. In some examples, part(s) of system architecture 200 can be implemented by part(s) of system architecture 100 of FIG. 1 to facilitate protection from unwanted behavior in remote appliances in a decentralized service mesh.

System architecture 200 comprises cloud environment 202, remote location 204, application 206, secure connection 208, appliance 210, and extended service mesh 212.

Consider a decentralized service mesh running in a cloud computing environment hosting a high-performance application. Networking and communication features can be distributed across multiple nodes rather than a centralized control plane. This same service mesh can be extended using secure communication methodologies enabling routing to globally distributed appliances or applications (endpoints).

A remote endpoint in this environment can be appliances deployed to a customer network that have been securely connected to a cloud environment. The secure communication mechanisms can be capable of bidirectional communication. That is, data can flow from the remote location back to a cloud environment, which can be hosted in a corporate network. Allowing data to flow in this direction can be a security risk, and can expose the cloud environment to unwanted traffic from the remote location.

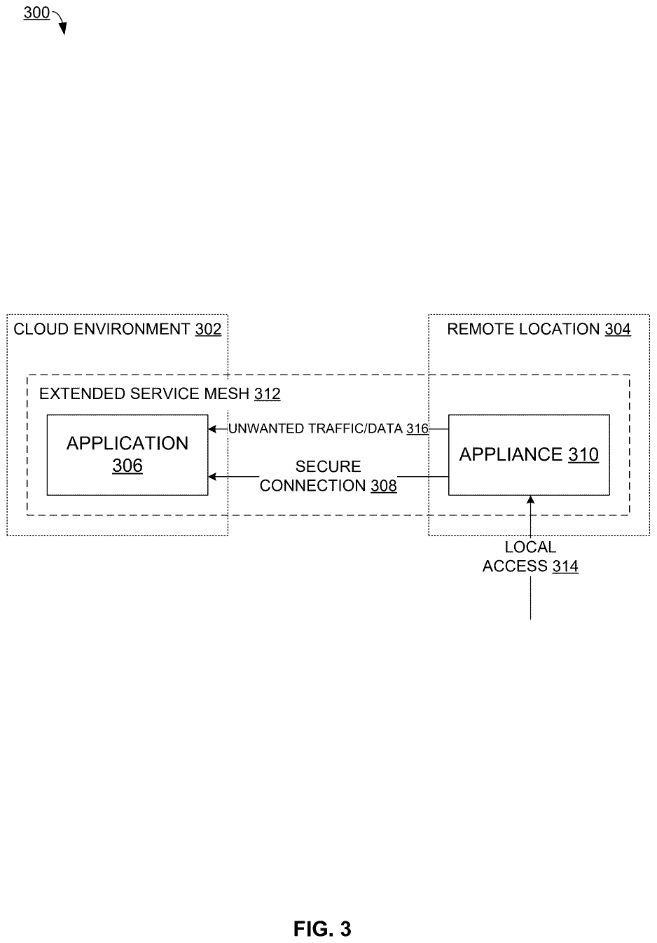

FIG. 3 illustrates another example system architecture 300 that can facilitate protection from unwanted behavior in remote appliances in a decentralized service mesh, in accordance with an embodiment of this disclosure. In some examples, part(s) of system architecture 300 can be implemented by part(s) of system architecture 100 of FIG. 1 to facilitate protection from unwanted behavior in remote appliances in a decentralized service mesh.

System architecture 300 comprises cloud environment 302, remote location 304, application 306, secure connection 308, appliance 310, extended service mesh 312, local access 314, and unwanted traffic/data 316.

Should a securely connected appliance in a remote location be misconfigured or enter into an unstable state, it can pose a stability risk to the cloud environment. While access to services within the cloud environment can still be protected by the authentication and authorization of the secure connectivity layer, these layers can still accept all authorized traffic and data. This can potentially expose the cloud environment to a large influx of unwanted data.

Detecting such an event and protecting against it can be challenging. Standard network security such as firewalls, network policies and a multiplexed Transport Layer Security protocol (mTLS) can restrict what services are reachable and validate the source of requests, but it can be that they do not prevent services receiving malicious requests and/or data if they come from a trusted source.

Possible undesirable scenarios can include:
An unexpected storm of large events from a remote appliance that has become unstable; and
Misconfigured telemetry generation in the appliance resulting in “telemetry spamming” from a remote appliance.

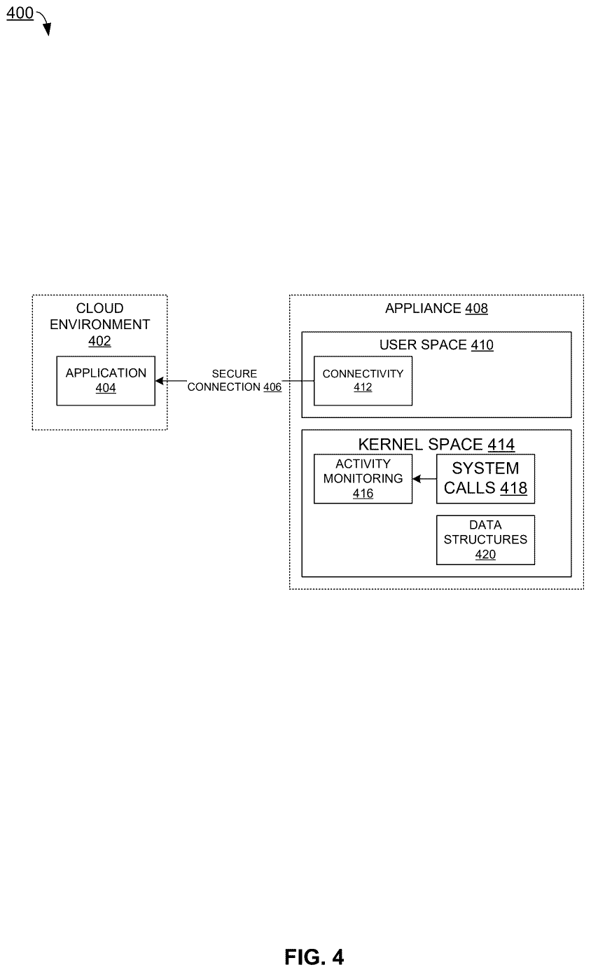

FIG. 4 illustrates another example system architecture 400 that can facilitate protection from unwanted behavior in remote appliances in a decentralized service mesh, in accordance with an embodiment of this disclosure. In some examples, part(s) of system architecture 400 can be implemented by part(s) of system architecture 100 of FIG. 1 to facilitate protection from unwanted behavior in remote appliances in a decentralized service mesh.

System architecture 400 comprises cloud environment 402, application 404, secure connection 406, appliance 408, user space 410, connectivity 412, kernel space 414, activity monitoring 416, system calls 418, and data structures 420.

The present techniques can address these problems in the following manner. If there were a program running in the remote appliance, it could be used to protect the cloud environment from an unwanted traffic or data from a remote appliance. Moreover, if this program were running in the kernel of the remote appliance, it could have access to:
Kernel events, which can be monitored as they are executed (e.g., storage, networking, filesystem or application system calls); and
In-kernel advanced statistical data structures (e.g., count-min sketch, per-central processing unit (CPU) data structures) to store system calls statistics, data, profiles, etc.

The present techniques can incorporate the following mechanisms:
Secure connectivity mechanisms to transparently allow communication between services in the cloud environment and endpoints in the remote appliance;
In-kernel system and application introspection to monitor kernel events and trigger actions (e.g., check compliance to profile, quarantine malicious events, store system calls in in-kernel data structures, and/or process according to profiles details); and
In-kernel advanced statistical data structures to store system calls, profiles, etc.

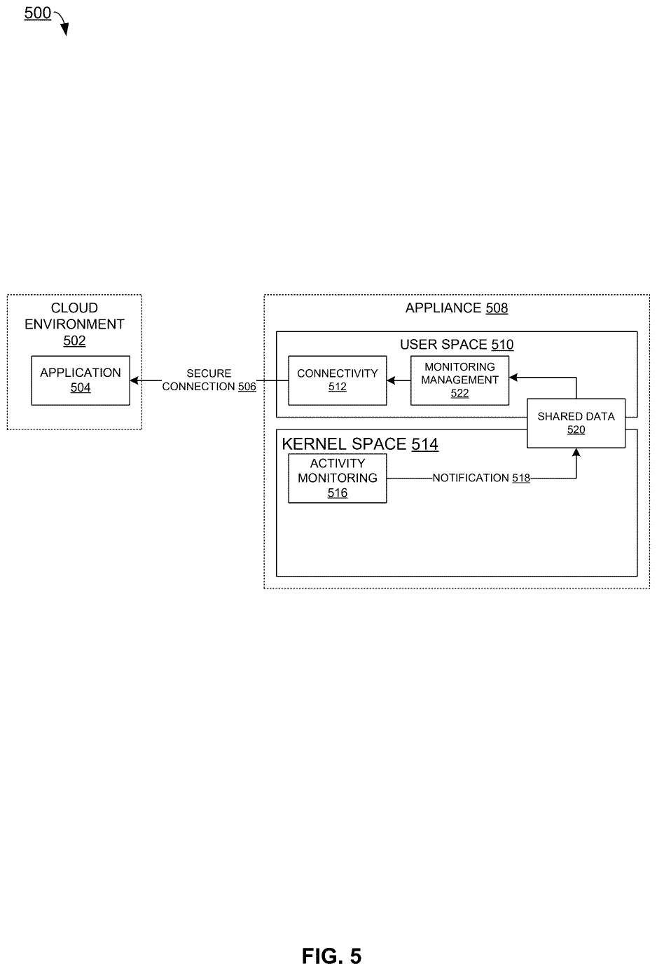

FIG. 5 illustrates another example system architecture 500 that can facilitate protection from unwanted behavior in remote appliances in a decentralized service mesh, in accordance with an embodiment of this disclosure. In some examples, part(s) of system architecture 500 can be implemented by part(s) of system architecture 100 of FIG. 1 to facilitate protection from unwanted behavior in remote appliances in a decentralized service mesh.

System architecture 500 comprises cloud environment 502, application 504, secure connection 506, appliance 508, user space 510, connectivity 512, kernel space 514, activity monitoring 516, notification 518, shared data 520, and monitoring management 522.

According to the present techniques, the monitoring program can have a profile of expected traffic flow from that appliance. Observed activity in the appliance can be compared to this profile. If a deviation from this profile is detected, the monitoring program can identify this as a risk that the remote appliance is exhibiting unwanted behavior. Should this risk breach a certain threshold, the monitoring program can take appropriate actions such as:
Notifying the cloud environment that this remote appliance is exhibiting unwanted behavior, allowing the cloud environment to take appropriate action; and/or
Terminating the secure connection back to the cloud.

It can be that programs running in a node's kernel generally do not communicate directly with applications running outside of its node. Operations like this can be allowed to run in the user space. However, it can be possible for programs running in the user space to share data with programs running in the kernel space through system calls.

While the termination of the secure connectivity can be performed from the kernel, a companion program can run in the user space to enable the notification transmission.

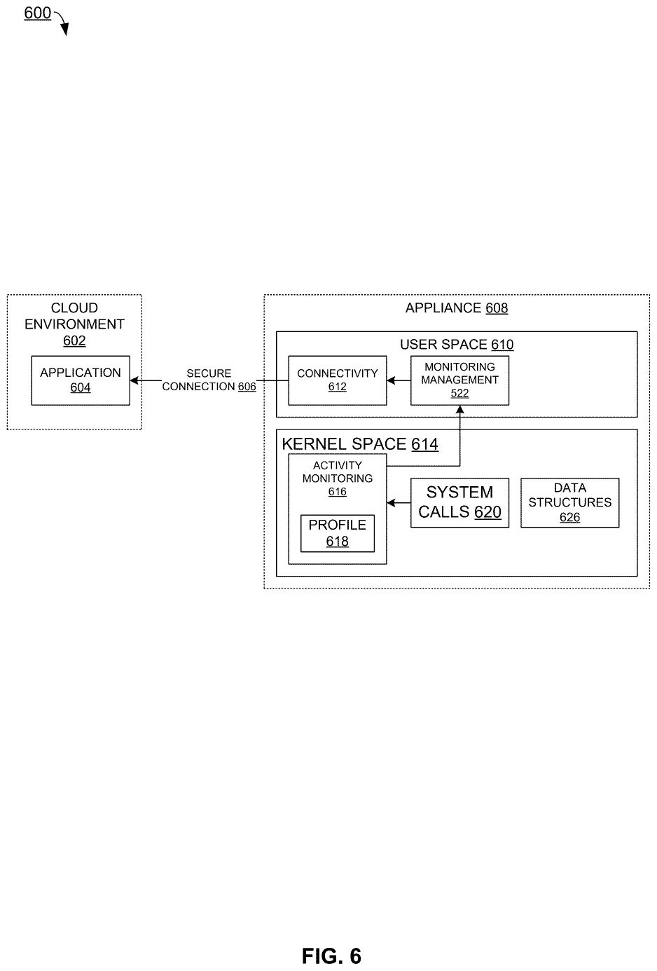

FIG. 6 illustrates another example system architecture 600 that can facilitate protection from unwanted behavior in remote appliances in a decentralized service mesh, in accordance with an embodiment of this disclosure. In some examples, part(s) of system architecture 600 can be implemented by part(s) of system architecture 100 of FIG. 1 to facilitate protection from unwanted behavior in remote appliances in a decentralized service mesh.

System architecture 600 comprises cloud environment 602, application 604, secure connection 606, appliance 608, user space 610, connectivity 612, kernel space 614, activity monitoring 616, profile 618, system calls 620, monitoring management 622, and data structures 624.

The monitoring program can intercept and inspect kernel level operations as follows:
Operation intercepted;
Check against configured activity profile; and
Trigger action plan
Do nothing—expected operation;
Block operation—telemetry spamming or unwanted data transmission via secure connection, etc.;
Store operations in in-kernel data structures for further analysis (e.g. count-min sketch, per-CPU data structures);
Trigger notification to cloud environment; and/or
Disable outbound secure connectivity.

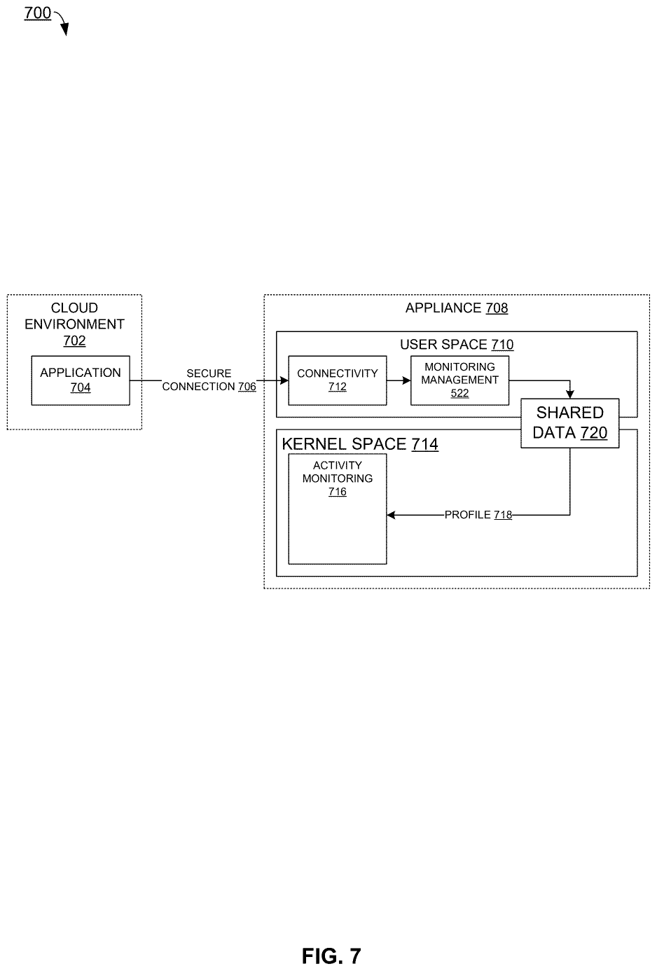

FIG. 7 illustrates another example system architecture 700 that can facilitate protection from unwanted behavior in remote appliances in a decentralized service mesh, in accordance with an embodiment of this disclosure. In some examples, part(s) of system architecture 700 can be implemented by part(s) of system architecture 100 of FIG. 1 to facilitate protection from unwanted behavior in remote appliances in a decentralized service mesh.

System architecture 700 comprises cloud environment 702, application 704, secure connection 706, appliance 708, user space 710, connectivity 712, kernel space 714, activity monitoring 716, profile 718, shared data 720, and monitoring management 722.

The control plane in the cloud environment can also update the monitoring profile of the activity monitoring component running in the kernel of the remote appliance. This can be in response to discussions with the customer hosting the remote appliance or part of a configuration update.

As before, it can be that applications running outside of the kernel do not have direct access to programs running in the kernel, so it can be that this action is facilitated by the companion program running in the user space. This program can receive a profile update via the secure connectivity mechanism and share it with the activity monitoring program via the shared data between the user space and kernel space.

### Example Process Flows

FIG. 8 illustrates another example process flow 800 that can facilitate protection from unwanted behavior in remote appliances in a decentralized service mesh, in accordance with an embodiment of this disclosure. In some examples, one or more embodiments of process flow 800 can be implemented by protection from unwanted behavior in remote appliances in a decentralized service mesh component 108 of FIG. 1, or computing environment 1100 of FIG. 11.

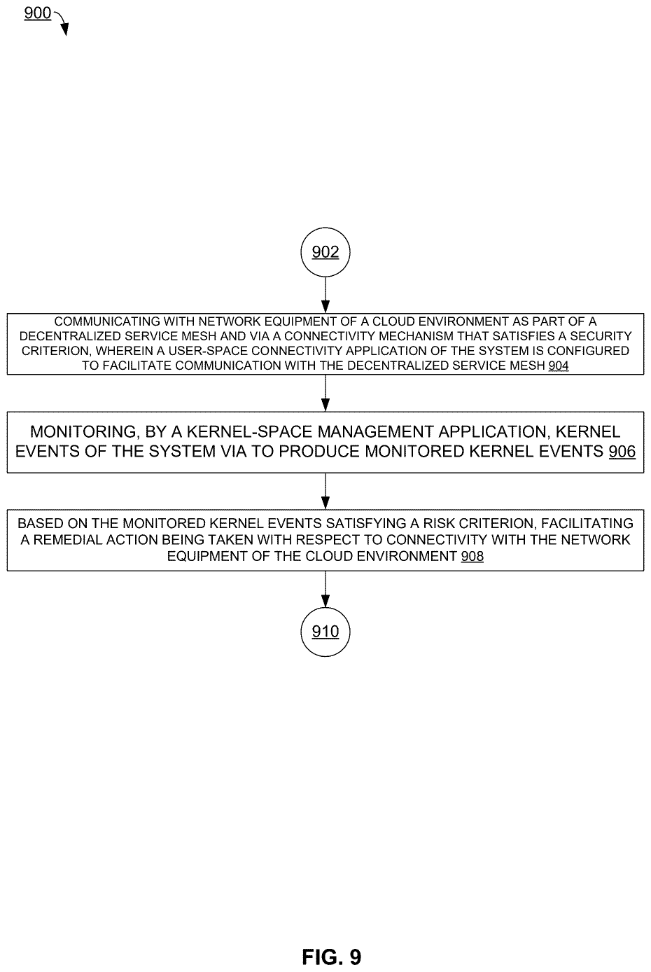

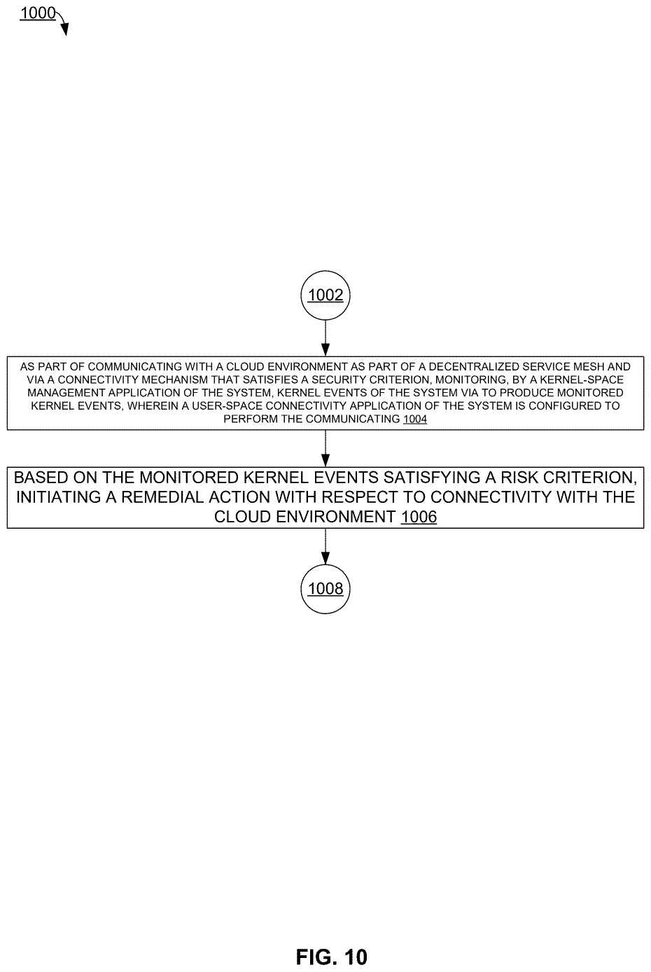

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow process flow 900 of FIG. 9, and/or process flow 1000 of FIG. 10.

Process flow 800 begins with 802, and moves to operation 804.

Operation 804 depicts connecting to cloud computing equipment of a cloud environment as part of a decentralized service mesh that comprises the cloud computing equipment of the cloud environment and the system via a connectivity mechanism that satisfies a security criterion, wherein a user-space connectivity application of the system is configured to facilitate communication with the decentralized service mesh, and wherein a kernel-space management application of the system is configured to monitor kernel events of the system. That is, there can be a remote endpoint in a decentralized service mesh, which comprises a user-space connectivity application and a kernel-space management application. Using the example of FIG. 1, the remote endpoint can be remote computer 106, which forms a decentralized service mesh with computer system 102. The user-space connectivity application can be similar to connectivity component (user space) 110, and the kernel-space management application can be similar to activity monitoring component (kernel space) 112.

In some examples, a system that implements process flow 800 comprises a remote endpoint of the decentralized service mesh.

After operation 804, process flow 800 moves to operation 806.

Operation 806 depicts monitoring the kernel events at the system via the kernel-space management application to produce monitored kernel events. Continuing with the example of FIG. 1, this can comprise activity monitoring component (kernel space) 112 monitoring the kernel events of remote computer 106.

In some examples, the kernel events comprise a storage system call, a networking system call, a filesystem call, or an application system call.

In some examples, the monitored kernel events are stored in at least one count-min sketch data structure in a kernel space of the system. In some examples, respective kernel events of the monitored kernel events correspond to respective processors of the at least one processor, and the respective kernel events are stored in respective per-processor data structures in a kernel space of the system. These can be in-kernel advanced statistical data structures (e.g., count-min sketch, per-CPU data structures) to store system calls statistics, data, profiles, etc.

After operation 806, process flow 800 moves to operation 808.

Operation 808 depicts, based on the monitored kernel events being determined to satisfy a risk criterion, taking a remedial action with respect to connectivity with the cloud computing equipment of the cloud environment. This remedial action can include actions such as raising an alert, and (continuing with the example of FIG. 1) terminating a connection between remote computer 106 and computer system 102.

In some examples, the risk criterion corresponds to a profile of expected traffic from the system and to the cloud computing equipment of the cloud environment. In some examples, operation 808 comprises receiving an indication of the profile of expected traffic from the cloud computing equipment of the cloud environment. That is, a monitoring program can have a profile of expected traffic flow from that appliance. Observed activity in the appliance can be compared to this profile. If a deviation from this profile is detected, the monitoring program can identify this as a risk that the remote appliance is exhibiting unwanted behavior.

In some examples, the taking of the remedial action with respect to the connectivity with the cloud environment comprises sending, to the cloud computing equipment of the cloud environment, an indication that the monitored kernel events satisfy the risk criterion.

In some examples, the sending of the indication that the monitored kernel events satisfy the risk criterion comprises instructing, by the kernel-space management application, the user-space connectivity application to send the indication, wherein the sending is performed by the user-space connectivity application.

In some examples, the taking of the remedial action with respect to the connectivity with the cloud computing equipment of the cloud environment comprises terminating the connectivity with the cloud computing equipment of the cloud environment. In some examples, the terminating is performed by the kernel-space management application.

That is, should the detected risk breach a certain threshold, the monitoring program can take appropriate actions such as, notifying the cloud environment that this remote appliance is exhibiting unwanted behavior, allowing the cloud environment to take appropriate action; and/or terminating the secure connection back to the cloud.

After operation 808, process flow 800 moves to 810, where process flow 800 ends.

FIG. 9 illustrates another example process flow 900 that can facilitate protection from unwanted behavior in remote appliances in a decentralized service mesh, in accordance with an embodiment of this disclosure. In some examples, one or more embodiments of process flow 900 can be implemented by protection from unwanted behavior in remote appliances in a decentralized service mesh component 108 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 800 of FIG. 8, and/or process flow 1000 of FIG. 10.

Process flow 900 begins with 902, and moves to operation 904.

Operation 904 depicts communicating with network equipment of a cloud environment as part of a decentralized service mesh and via a connectivity mechanism that satisfies a security criterion, wherein a user-space connectivity application of the system is configured to facilitate communication with the decentralized service mesh. In some examples, operation 904 can be implemented in a similar manner as operation 804 of FIG. 8.

After operation 904, process flow 900 moves to operation 906.

Operation 906 depicts monitoring, by a kernel-space management application, kernel events of the system via to produce monitored kernel events. In some examples, operation 906 can be implemented in a similar manner as operation 806 of FIG. 8.

After operation 906, process flow 900 moves to operation 908.

Operation 908 depicts, based on the monitored kernel events satisfying a risk criterion, facilitating a remedial action being taken with respect to connectivity with the network equipment of the cloud environment. In some examples, operation 908 can be implemented in a similar manner as operation 808 of FIG. 8.

In some examples, the facilitating of the remedial action being taken with respect to the connectivity with the network equipment of the cloud environment comprises blocking a data transfer to the network equipment of the cloud environment independently of terminating a connection of the connectivity mechanism. That is, a remedial action can comprise blocking an operation (which can be telemetry spamming or unwanted data transmission via the connection to the rest of the decentralized service mesh).

In some examples, operation 908 comprises receiving, via the user-space connectivity application, an indication of a profile of expected traffic from the network equipment of the cloud environment, and communicating, by the user-space connectivity application, the indication of the profile to the kernel-space management application, wherein the risk criterion is based on the profile.

In some examples, the communicating of the indication of the profile to the kernel-space management application is performed via a memory region that is shared between a user space of the system and a kernel space of the system.

That is, it can be that applications running outside of the kernel do not have direct access to programs running in the kernel, so it can be that this action is facilitated by the companion program running in the user space. This program can receive a profile update via the secure connectivity mechanism and share it with the activity monitoring program via the shared data between the user space and kernel space.

After operation 908, process flow 900 moves to 910, where process flow 900 ends.

FIG. 10 illustrates another example process flow 1000 that can facilitate protection from unwanted behavior in remote appliances in a decentralized service mesh, in accordance with an embodiment of this disclosure. In some examples, one or more embodiments of process flow 1000 can be implemented by protection from unwanted behavior in remote appliances in a decentralized service mesh component 108 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 800 of FIG. 8, and/or process flow 900 of FIG. 9.

Process flow 1000 begins with 1002, and moves to operation 1004.

Operation 1004 depicts, as part of communicating with a cloud environment as part of a decentralized service mesh and via a connectivity mechanism that satisfies a security criterion, monitoring, by a kernel-space management application of the system, kernel events of the system via to produce monitored kernel events, wherein a user-space connectivity application of the system is configured to perform the communicating. In some examples, operation 1004 can be implemented in a similar manner as operations 804-806 of FIG. 8.

That is, control and management plane functions of the decentralized service mesh are distributed across a group of nodes of the decentralized service mesh.

After operation 1004, process flow 1000 moves to operation 1006.

Operation 1006 depicts based on the monitored kernel events satisfying a risk criterion, initiating a remedial action with respect to connectivity with the cloud environment. In some examples, operation 1006 can be implemented in a similar manner as operation 808 of FIG. 8.

In some examples, the risk criterion is based on a rate of requests to transmit outbound packets satisfies an upper limit on rate criterion. That is, a request_count can be captured by high-performance packet data path executions. If this exceeds a defined max_requests_per_sec, the secure connection can be terminated until the requests reduce to an acceptable level.

In some examples, the risk criterion is based on a rate of outbound data transfer satisfies an upper limit on bandwidth criterion. That is, a bytes_count can be captured by high-performance packet data path executions. If this exceeded a defined max_bytes_per_sec, the secure connection can be terminated until the requests reduce to an acceptable level.

In some examples, the risk criterion is based on a request to access a hostname that is different than defined acceptable hostname parameters. That is, a pattern for acceptable hostnames can be defined within the activity monitoring program. If the appliance repeatedly tries to connect to hosts outside of this pattern via the secure connection, it can be terminated until the connectivity requests reduce to an acceptable level.

After operation 1006, process flow 1000 moves to 1008, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of computer system 102, and/or remote computer 106.

In some examples, computing environment 1100 can implement one or more embodiments of the process flows of FIGS. 8-10 to facilitate protection from unwanted behavior in remote appliances in a decentralized service mesh.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
connecting to cloud computing equipment of a cloud environment as part of a decentralized service mesh that comprises the cloud computing equipment of the cloud environment and the system via a connectivity mechanism that satisfies a security criterion, wherein a user-space connectivity application of the system is configured to facilitate communication with the decentralized service mesh, and wherein a kernel-space management application of the system is configured to monitor kernel events of the system;
monitoring the kernel events at the system via the kernel-space management application to produce monitored kernel events; and
based on the monitored kernel events being determined to satisfy a risk criterion, taking a remedial action with respect to connectivity with the cloud computing equipment of the cloud environment.

2. The system of claim 1, wherein the system comprises a remote endpoint of the decentralized service mesh.

3. The system of claim 1, wherein the kernel events comprise a storage system call, a networking system call, a filesystem call, or an application system call.

4. The system of claim 1, wherein the monitored kernel events are stored in at least one count-min sketch data structure in a kernel space of the system.

5. The system of claim 1, wherein respective kernel events of the monitored kernel events correspond to respective processors of the at least one processor, and wherein the respective kernel events are stored in respective per-processor data structures in a kernel space of the system.

6. The system of claim 1, wherein the risk criterion corresponds to a profile of expected traffic from the system and to the cloud computing equipment of the cloud environment.

7. The system of claim 6, wherein the operations further comprise:
receiving an indication of the profile of expected traffic from the cloud computing equipment of the cloud environment.

8. The system of claim 1, wherein the taking of the remedial action with respect to the connectivity with the cloud environment comprises:
sending, to the cloud computing equipment of the cloud environment, an indication that the monitored kernel events satisfy the risk criterion.

9. The system of claim 8, wherein the sending of the indication that the monitored kernel events satisfy the risk criterion comprises:
instructing, by the kernel-space management application, the user-space connectivity application to send the indication, wherein the sending is performed by the user-space connectivity application.

10. The system of claim 1, wherein the taking of the remedial action with respect to the connectivity with the cloud computing equipment of the cloud environment comprises:
terminating the connectivity with the cloud computing equipment of the cloud environment.

11. The system of claim 10, wherein the terminating is performed by the kernel-space management application.

12. A method, comprising:
communicating, by a system comprising at least one processor, with network equipment of a cloud environment as part of a decentralized service mesh and via a connectivity mechanism that satisfies a security criterion, wherein a user-space connectivity application of the system is configured to facilitate communication with the decentralized service mesh;
monitoring, by a kernel-space management application of the system, kernel events of the system via to produce monitored kernel events; and
based on the monitored kernel events satisfying a risk criterion, facilitating, by the system, a remedial action being taken with respect to connectivity with the network equipment of the cloud environment.

13. The method of claim 12, wherein the facilitating of the remedial action being taken with respect to the connectivity with the network equipment of the cloud environment comprises:
blocking a data transfer to the network equipment of the cloud environment independently of terminating a connection of the connectivity mechanism.

14. The method of claim 12, further comprising:
receiving, via the user-space connectivity application, an indication of a profile of expected traffic from the network equipment of the cloud environment; and
communicating, by the user-space connectivity application, the indication of the profile to the kernel-space management application, wherein the risk criterion is based on the profile.

15. The method of claim 14, wherein the communicating of the indication of the profile to the kernel-space management application is performed via a memory region that is shared between a user space of the system and a kernel space of the system.

16. A non-transitory computer-readable medium comprising instructions that, in response to execution, cause a system comprising at least one processor to perform operations, comprising:
as part of communicating with a cloud environment as part of a decentralized service mesh and via a connectivity mechanism that satisfies a security criterion, monitoring, by a kernel-space management application of the system, kernel events of the system via to produce monitored kernel events, wherein a user-space connectivity application of the system is configured to perform the communicating; and
based on the monitored kernel events satisfying a risk criterion, initiating, by the system, a remedial action with respect to connectivity with the cloud environment.

17. The non-transitory computer-readable medium of claim 16, wherein the risk criterion is based on a rate of requests to transmit outbound packets satisfies an upper limit on rate criterion.

18. The non-transitory computer-readable medium of claim 16, wherein the risk criterion is based on a rate of outbound data transfer satisfies an upper limit on bandwidth criterion.

19. The non-transitory computer-readable medium of claim 16, wherein the risk criterion is based on a request to access a hostname that is different than defined acceptable hostname parameters.

20. The non-transitory computer-readable medium of claim 16, wherein control and management plane functions of the decentralized service mesh are distributed across a group of nodes of the decentralized service mesh.
